(19) United States
(12) Patent Application Publication
(10) Pub. No.: US 2007/0057777 A1
(43) Pub. Date: Mar. 15, 2007

(54) Piezoelectric sound-maker with reflector

(75) Inventors: George A. Burnett, Clayton, IN (US); Joshua Brown, Danville, IN (US)

Correspondence Address: NIRO, SCAVONE, HALLER & NIRO, 181 W. MADISON, SUITE 4600, CHICAGO, IL, 60602, US

(73) Assignee: Mallory Sonalert Products, Inc.

(21) Appl. No.: 11/223,674

(22) Filed: Sep. 9, 2005

(51) Int. Cl. G08B 3/10

(52) U.S. Cl. 340/384.4

(57) ABSTRACT

An electronic audio circuit operates a piezoelectric audio transducer whose emitted sound is directed at a parabolic reflecting dish to produce an increased sound output.

### BACKGROUND OF THE INVENTION

Alarms and audible indicators have achieved widespread popularity in many applications. Of the countless examples available, just a few are sirens on emergency vehicles, in-home fire and carbon monoxide alarms, danger warnings on construction machines when the transmission is placed in reverse, factory floor danger warnings, automobile seat belt reminders, medical devices, and many more. Audio tone signaling devices are used to signal functions such as the end of an operating cycle, the end of a period of time, a warning, or a reminder. It is nearly a truism that industry prefers inexpensive but high quality devices to create such alarms and indicator sounds. Piezoelectric warbling audio devices are often selected for applications with limited space and for operation in harsh environments.

Piezoelectric transducers are sound producing electronic devices that are preferred by industry because they are by and large extremely inexpensive, reliable, durable, and versatile. This transducer has the unique property that it undergoes a reversible mechanical deformation on the application of an electrical potential across it. Conversely, it also generates an electrical potential upon mechanical deformation. These characteristics make it highly desirable for sound producing applications. When an oscillating potential is placed across the transducer, it vibrates at roughly the same frequency as the oscillations. These vibrations are transmitted to the ambient medium, such as air, to become sound waves. Piezoelectric transducers can also be coupled to a simple circuit in what is known as a feedback mode, well known in the art, in which there is an additional feedback terminal located on the element. In this mode, the crystal will oscillate at a natural, resonant frequency without the need for continuous applied driving oscillations. As long as the oscillations are in the range of audible sound, i.e., 20 to 20,000 Hertz, such oscillations can produce an alarm or an indicator.

This invention relates to piezoelectric transducers used in audio tone signaling devices, and more particularly to increasing the volume of the transducer output.

A number of these devices are shown in patents such as U.S. Pat. No. 4,213,121, “Chime Tone Audio System Utilizing a Piezoelectric Transducer,” U.S. Pat. No. 4,697,932, “Multi-Signal Alarm,” U.S. Pat. No. 5,675,311, “Frequency Sweeping Audio Signal Device,” U.S. Pat. No.5,675,312, “Piezoelectric Warbler,” U.S. Pat. No. 5,872,506, “Piezoelectric Transducer Having Directly Mounted Electrical Components and Noise Making Device Utilizing Same,” U.S. Pat. Nos. 6,131,618 and 6,414,604, “Piezoelectric Transducer Assembly for Enhanced Functionality,” U.S. Pat. Nos. 6,512,450 and 6,756,883, “Extra Loud Low Frequency Acoustical Alarm Assembly,” and U.S. Pat. No. 6,617,967, “Piezoelectric Siren Driver Circuit.” Some of these patents address electrical circuitry, while others address structural components. The '450 and '883 patents are examples of ways to increase the sound produced by a piezoelectric device.

There is an increasing demand for louder devices. What is needed is a piezoelectric audio signaling device that provides greater volume without substantially increasing the size of the device. This patent shows an additional means of increasing the sound output of such a device.

### SUMMARY OF THE INVENTION

According to the invention, a parabolic reflector is placed to reflect and concentrate sound waves created by an oscillating piezoelectric transducer coupled to an electrical circuit of the kind shown in the above patents. The concentration of the sound waves increases the sound output by ten to fifteen dB.

It is an object of the invention to provide a simple, inexpensive piezoelectric audio device circuit with increased sound volume.

It is another object of the invention to provide a piezoelectric circuit that occupies very little residential space in a piezoelectric audio tone signaling device housing.

### DESCRIPTION OF THE DRAWINGS

These and other features, aspects, and advantages of the present invention will become understood with regard to the following description, appended claims, and accompanying drawings where:

FIG. 1 shows a piezoelectric audio transducer placed at the focal point of a parabolic reflector;

FIG. 2 shows an alternative location for the transducer; and

FIG. 3 shows the housing of U.S. Pat. No. 6,512,540 incorporating the reflector of the invention.

### DETAILED DESCRIPTION OF THE EMBODIMENTS

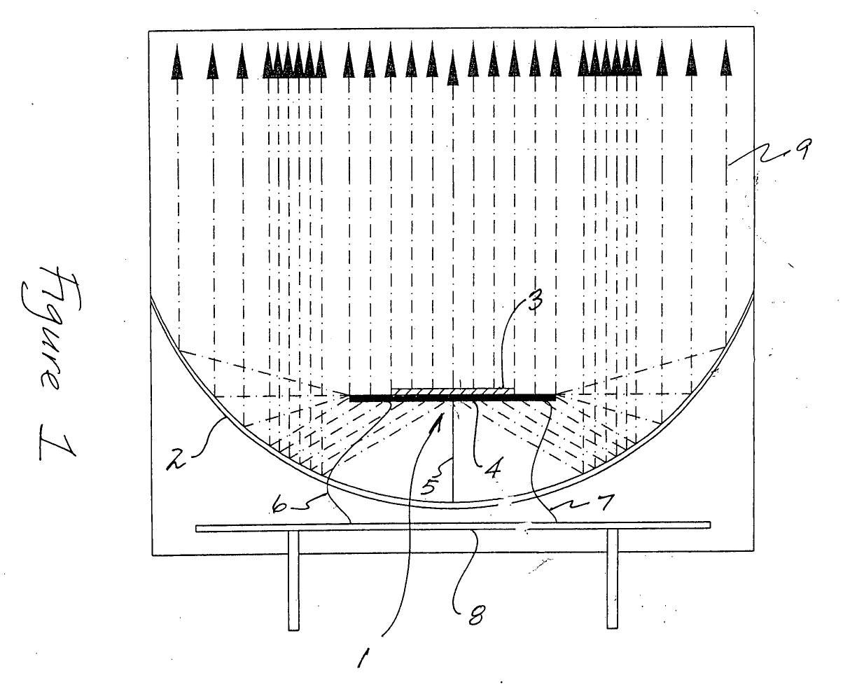

Referring to FIG. 1, a piezoelectric transducer 1 is placed at the focal point of a parabolic dish 2. The transducer 1 consists of a metal plate 4 with a ceramic backing 3. The transducer 1 is mounted to the parabolic dish 2 by a post 5 securely fastened to both transducer 1 and dish 2. The transducer 1 is electrically connected by leads 6 and 7 to a printed circuit board 8. The reflecting parabolic dish can be attached to or incorporated in a housing, which is omitted from FIG. 1 for clarity.

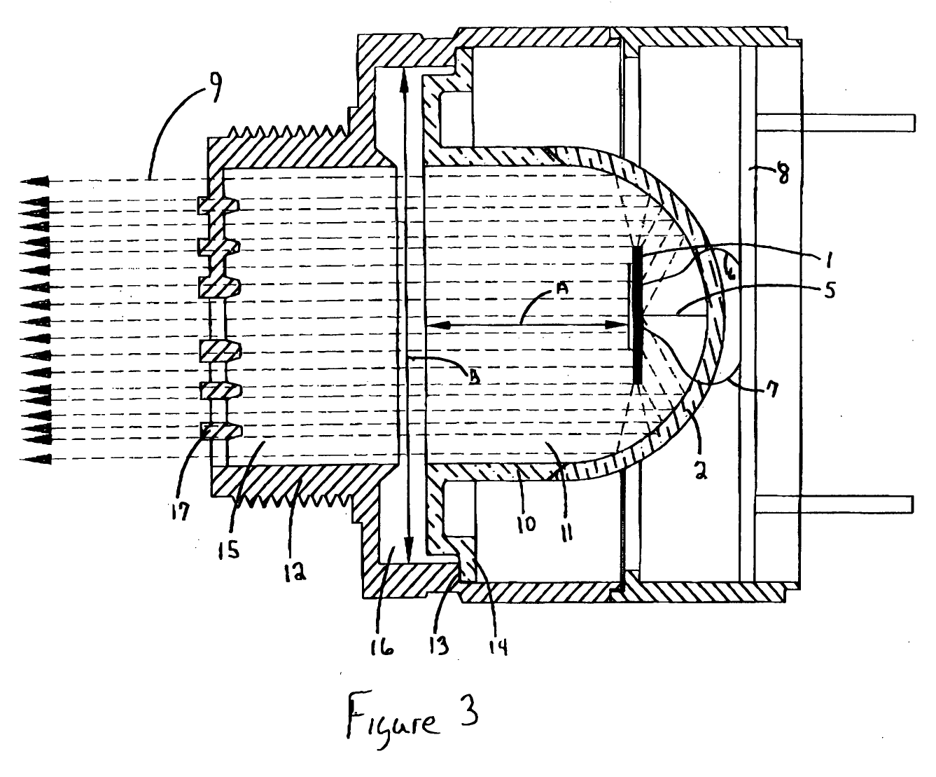

One example of a typical housing that may be used with the invention is shown in FIG. 3. There is a piezoelectric transducer 1. The transducer 1 is mounted to the parabolic dish 2 by a post 5 securely fastened to both transducer 1 and dish 2. The transducer 1 is electrically connected by leads 6 and 7 to a printed circuit board 8. While mounting the transducer at or near its nodal diameter (not shown) is not essential to the invention, doing so will minimize interference with flexing of transducer 1, thus improving its sound-emitting qualities.

Housing insert 10 is cylindrical in cross-section and hollow, forming a sound-amplifying cavity 11 next to the transducer 1. One suitable material for housing insert 10 is 6/6 nylon or “ABS.” A source for 6/6 nylon is Zytel 101 available from Pro Tech Plastic Inc., 1295 West Helena Drive, West Chicago, Ill., 60185. The length “A” of housing 10 is adjusted to maximize the amplification.

A main housing 12 is cylindrical in cross-section and hollow. Main housing 12 is attached to an end of housing insert 10. A flange 13 on main housing 12 engages and is secured by any convenient means to a flange 14 on insert 10. Main housing 12 is hollow, and has two cylindrical sections with different diameters. One cylindrical section forms a sound-amplifying cavity 15, and a second larger cylindrical section forms another sound-amplifying cavity 16. The diameters of cavities 15 and 11 are typically about the same, whereas the diameter “B” of cavity 16 is larger. A grill 17 may be attached to the end of housing 12 away from the transducer 1, and allows sound produced by the transducer, and amplified in the cavities, to be emitted and heard.

The housing previously described is generally depicted in U.S. Pat. No. 6,512,450, “Extra-Loud Frequency Acoustical Alarm Assembly”. Another housing which can be used with the present invention is shown in U.S. Pat. No. 6,756,883, “Extra-Loud Frequency Acoustical Alarm Assembly”. These patents are owned by the assignee of the present invention. Other housings, such as ones without sound-amplifying qualities, may be used as well.

The associated electrical circuitry is omitted from the drawings for clarity, but one of skill in the art will recognize that a variety of circuits can be used, for example, those shown in the patents identified above. For example, the driving circuitry from U.S. Pat. No. 6,310,540, “Multiple Signal Audible Oscillator Generator” or the driving circuitry from U.S. Pat. No. 5,990,784, “Schmitt Trigger Loud Alarm With Feedback” may be used. These patents are owned by the assignee of the present invention. Additional circuits are shown in the Mallory Sonalert Product Catalog; see page 18, “Mallory Piezo Transducers—Typical Drive Circuits.” This catalog is presently available at the Mallory website, located at http://www.mallory-sonalert.com.

Here, the driving circuit from a Mallory Sonalert Products, Inc. Sonalert® Audible Signal Device, part number MSR516N, available from Mallory Sonalert Products, Inc., 4411 South High. School Road, Indianapolis, Indiana, was used. The transducer and nodal mounted plastic ring from a MSR516N Signal Device was used as well. The MSR516N is rated to produce 3850+400 Hz with a sound pressure of from 75 to 86 dB(A) at two feet. Its operating characteristics are described at page 9 of the Mallory Sonalert catalog available from Mallory Sonalert Products, Inc., and at http://www.mallory-sonalert.com. The parabolic dish was 1.27 inches in diameter, and made of plastic.

Oscillation of the transducer 1 creates sound waves 9 which radiate from the transducer 1. These waves are intercepted by, and reflect from, parabolic dish 2. The dish aligns the direction of travel of the waves.

The piezoelectric transducer was tested both with and without parabolic dish 2. A Bruel and Kjaer dB meter was used to measure the sound output. In the first test, no parabolic dish was used. The sound output measured two feet from the transducer was 75.2 dB.

Next, the transducer 1 was mounted with parabolic dish 2 as shown in FIG. 1, and the sound output was measured two feet from the transducer, using the same dB meter. The power input was the same. This time, however, the sound output was 93.7 dB. Since this is a logarithmic scale, the difference represents a significant increase in sound power at the same point. This significant increase is believed to be due to the fact that the waves emitted from the transducer toward the dish normally would not be heard by a listener in front of the transducer. But, when the waves are reflected, they are heard, and add to the waves emitted from the side of the transducer toward the listener.

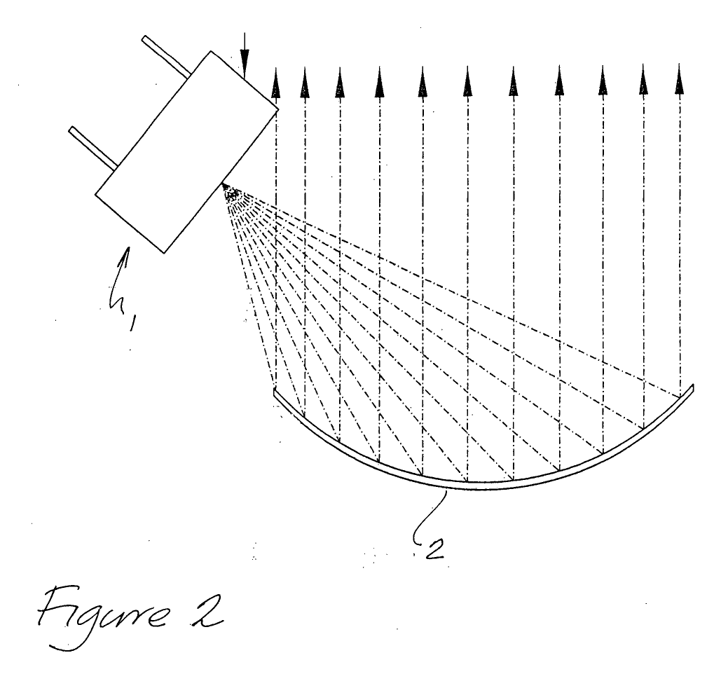

An alternate configuration was tested as well. This configuration is shown in FIG. 2, where parabolic dish 2 was approximately nineteen inches in diameter. Transducer 1 was placed to one side; the exact position is a matter of experimentation. In this case, transducer 1 was approximately 12.5 inches from the center point of the dish to the center of the transducer 1. Parabolic dish 2 was obtained from an RCA satellite receiver. Again, a driving circuit from a Mallory Sonalert Products, Inc. Sonalert® Audible Signal Device, part number MSR516N, was used. The transducer and nodal mounted plastic ring from a MSR516N Signal Device was used as well. The same Bruel and Kjaer dB meter was used to measure the sound output.

In the first test, no parabolic dish was used. The sound output measured two feet from the transducer was 92.0 dB. When the test was repeated with transducer 1 and dish 2 positioned as shown in FIG. 2, the sound output at three feet increased from 92.0 dB to 98.7 dB. This represents a sound level of approximately 101.7 dB at two feet. Again, the increase is significant.

What is claimed is:

1. A piezoelectric audio device comprising:
a parabolic reflecting dish;
a piezoelectric transducer positioned at the focal point of the parabolic reflecting dish;
a electrical circuit connected to the transducer for causing the transducer to oscillate at an audible frequency;
whereby sound waves generated by the oscillating transducer, and directed toward the parabolic dish, are reflected by the parabolic dish, thus increasing the sound pressure level measured at a point spaced from the side of the transducer away from the parabolic reflector.

2. The piezoelectric audio device of claim 1 wherein the electrical circuit further comprises:
first and second Schmitt triggers each having a respective Schmitt trigger input and Schmitt trigger output, the second Schmitt trigger input electrically coupled to the first Schmitt trigger output;
a circuit for receiving a sequence of electrical oscillations at the first Schmitt trigger input, the oscillations being in the audible frequency range, the input allowing a high potential state to appear at the first Schmitt trigger input during one of respective high and low phases of the oscillations and a low potential state to appear during the other of the respective high and low phases;
an output of the first Schmitt trigger connected to the piezoelectric transducer; and
an output of the second Schmitt trigger connected to the piezoelectric transducer.

3. The piezoelectric audio device of claim 1 wherein the electrical circuit further comprises:
a voltage supply;
a controller having a controller input and a controller output;
a driving circuit connected to the controller output and operating in a manner to supply an amplitude of about twice the supply voltage; and
the controller selectively responsive to a plurality of selection signals whereby upon receipt by the controller of a predetermined one of the plurality of selection signals, the controller generates a corresponding sequence of electrical oscillations at the controller output, the oscillations essentially in the audible frequency range.

4. The piezoelectric audio device of claim 1 and further comprising a housing including:
a first sound-amplifying chamber attached to the piezoelectric transducer, the chamber enclosing a space communicating with the transducer for receiving sound waves from the transducer, the first chamber having a diameter approximately equal to the nodal diameter of the transducer; and
a second sound-amplifying chamber enclosing a second space in communication with the space in the first chamber for receiving sound waves from the first chamber, the second chamber having a diameter between approximately one and two times the diameter of the first chamber.

5. The piezoelectric audio device of claim 1 and further comprising a housing including:
a first sound-amplifying chamber attached to the piezoelectric transducer, the chamber enclosing a space communicating with the transducer for receiving sound waves from the transducer, the first chamber having a diameter approximately equal to the nodal diameter of the transducer;
a second sound-amplifying chamber enclosing a second space in communication with the space in the first chamber for receiving sound waves from the first chamber, the second chamber having a diameter between approximately one and two times the diameter of the first chamber; and
a third sound-amplifying chamber enclosing a space communicating with the second chamber and receiving sound waves from the second chamber, the third chamber having a diameter approximately equal to the nodal diameter of the transducer.

6. A piezoelectric audio device comprising:
a parabolic reflecting dish;
a piezoelectric transducer offset by an angle of from thirty to sixty degrees from the axis of the parabolic reflecting dish;
an electrical circuit connected to the transducer for causing the transducer to oscillate at an audible frequency;
whereby sound waves generated by the oscillating transducer, and directed toward the parabolic dish, are reflected by the parabolic dish, thus increasing the sound pressure level measured at a point spaced from the side of the transducer away from the parabolic reflector.

7. The piezoelectric audio device of claim 6 wherein the electrical circuit further comprises:
first and second Schmitt triggers each having a respective Schmitt trigger input and Schmitt trigger output, the second Schmitt trigger input electrically coupled to the first Schmitt trigger output;
a circuit for receiving a sequence of electrical oscillations at the first Schmitt trigger input, the oscillations being in the audible frequency range, the input allowing a high potential state to appear at the first Schmitt trigger input during one of respective high and low phases of the oscillations and a low potential state to appear during the other of the respective high and low phases;
an output of the first Schmitt trigger connected to the piezoelectric transducer; and
an output of the second Schmitt trigger connected to the piezoelectric transducer.

8. The piezoelectric audio device of claim 6 wherein the electrical circuit further comprises:
a voltage supply;
a controller having a controller input and a controller output;
a driving circuit connected to the controller output and operating in a manner to supply an amplitude of about twice the supply voltage; and
the controller selectively responsive to a plurality of selection signals whereby upon receipt by the controller of a predetermined one of the plurality of selection signals, the controller generates a corresponding sequence of electrical oscillations at the controller output, the oscillations essentially in the audible frequency range.

9. The piezoelectric audio device of claim 6 and further comprising a housing including:
a first sound-amplifying chamber attached to the piezoelectric transducer, the chamber enclosing a space communicating with the transducer for receiving sound waves from the transducer, the first chamber having a diameter approximately equal to the nodal diameter of the transducer; and
a second sound-amplifying chamber enclosing a second space in communication with the space in the first chamber for receiving sound waves from the first chamber, the second chamber having a diameter between approximately one and two times the diameter of the first chamber.

10. The piezoelectric audio device of claim 6 and further comprising a housing including:
a first sound-amplifying chamber attached to the piezoelectric transducer, the chamber enclosing a space communicating with the transducer for receiving sound waves from the transducer, the first chamber having a diameter approximately equal to the nodal diameter of the transducer;
a second sound-amplifying chamber enclosing a second space in communication with the space in the first chamber for receiving sound waves from the first chamber, the second chamber having a diameter between approximately one and two times the diameter of the first chamber; and
a third sound-amplifying chamber enclosing a space communicating with the second chamber and receiving sound waves from the second chamber, the third chamber having a diameter approximately equal to the nodal diameter of the transducer.
